(19) United States
(12) Patent Application Publication
(10) Pub. No.: US 2020/0086328 A1
(43) Pub. Date: Mar. 19, 2020

(54) Cleaning Equipment for Use with Precipitator

(71) Applicant: Precision lceblast Corporation, Peshtigo, WI (US)

(72) Inventors: Keith R. Boye, Hobart, WI (US); Matthew D. Peterson, Green Bay, WI (US)

(21) Appl. No.: 16/574,381

(22) Filed: Sep. 18, 2019

Related U.S. Application Data
(60) Provisional application No. 62/732,754, filed on Sep. 18, 2018.

(51) Int. Cl. B03C 3/80; B24C 1/00

(52) U.S. Cl. CPC B03C 3/80; B01D 53/323; B24C 1/003

(57) ABSTRACT

Systems and methods for cleaning a precipitator including plates and wires associated therewith using dry ice blasting equipment are described. The dry ice blasting equipment primarily includes an elongate wand. The elongate wand is configured to blast dry ice at a high level of pressure to ensure that debris and biproduct that is caked or coated onto the plates and wires is disengaged from the plates and wires. For instance, the dry ice may be blasted at pressures of at least 100 pounds per square inch, and more preferably at least 400 pounds per square inch. To achieve this pressure, the wand may be at least 2 feet in length, and more preferably at least 6 feet in length.

### CROSS-REFERENCE TO RELATED APPLICATIONS

This present application claims priority on U.S. Provisional Patent Application Ser. No. 62/732,754, filed on Sep. 18, 2018 and entitled Cleaning Equipment for Use with Precipitator, the entire contents of which are hereby expressly incorporated by reference into the present application.

### BACKGROUND OF THE INVENTION

The invention relates generally to electrostatic precipitator equipment used in coal plants and, in particular, to equipment used to improve the ease with which plates and wires associated with the precipitator can be cleaned. The invention also relates to a method of cleaning the precipitator, plates, and wires.

A precipitator is a large piece filtration machinery designed to collect fly ash on the downstream side of a boiler in various types of fuel power plants. Fuel is introduced into the boiler to create a heat source inside of the boiler to heat steam pipes. When the steam pipes reach a desired temperature, steam is created. The biproduct of the fuel is discharged downstream of the boiler into an electrostatic precipitator. The electrostatic precipitator has multiple plates and wires having different sizes and depths. The plates and wires run along chambers having various configurations and separation distances between each plate and wire. In some traditional cases, the plates may have a depth of sixteen feet and a height of seventy-five feet. Due to the size of these plates, efficient cleaning access to the middle of the plates is very challenging.

During use, an electrically charged box containing the plates and wires become electrically charged, which creates static electricity. The static electricity results in a negative charge that allows the plates and wires to collect the dust and biproduct from the fuel that is burnt in the boiler. Over long durations of run time, these plates and wires become coated and fouled with the biproduct. When this happens, the plate and wires become less efficient When efficiency is compromised, the biproduct can pass through the electrostatic precipitator and exit the plant's exhaust stack. Obviously, this is an undesirable result.

Traditional methods of cleaning precipitators in the past consisted of water washing, sand or grit blasting, and pecan shell blasting. All of these methods constitute abrasive media blasting. While these methods were acceptable in the past, recent regulations have been passed that significantly impair these traditional types of cleaning methods. Regulations have been passed that prevent water washing from being used in this industry because there were health and environmental concerns associated with depositing water in ash ponds after the water had been used to clean these precipitators. For instance, when water is mixed with fly ash, sulfuric acid can be generated. Further, use of some abrasive medias has also been outlawed by the Environmental Protection Agency (EPA) due to high levels of silica in certain abrasive medias.

As a result, many types of alternative abrasive medias have been tried. Some of these materials have resulted in limited success in cleaning these precipitators. However, there are significant downfalls to use of the abrasive media because the abrasive media can significantly damage the plates and wires. This requires plants to invest significant amounts of capital on the repair and replacement of the plates, wires, and other precipitator components. Additional costs are incurred related to the disposal cost to remove the media once the blasting was completed.

Another cleaning method utilized in other industries is dry ice blasting. Traditionally, dry ice blasting occurs using relative low pressure. For instance, many dry ice blasting cleaning procedures blast the dry ice using pressures ranging between 80-100 pounds per square inch and a similarly low velocity. This was at least partly due to the fact that the wands used in traditional dry ice blasting procedures are relatively short These short wands were used to increase movability and adjustability of the wand relative to whatever was being cleaned. Unfortunately, blasting material at such a low pressure is insufficient to adequately clean the precipitators because the debris forms a very strong bond with the wires and plates,

What is therefore needed is cleaning equipment that can efficiently clean preciptators including the wires and plates associated therewith. What is further needed is equipment that results in high pressure blasting in order to remove the biproduct and debris that is collected along the plates and wires. What is further needed is a method associated with cleaning precipitators including the wires and plates associated therewith.

### SUMMARY AND OBJECTS OF THE INVENTION

By way of summary, the present invention is directed to a cleaning equipment that is used to clean a precipitator and a method associated therewith. The precipitator may include a plurality of plates and wires. These plates and wires can be mounted within the precipitator at various locations and spacings. As a result of use of the precipitator, the plates and wires can become coated with waste biproduct that is difficult to remove and clean.

In accordance with a first aspect of the invention, the cleaning equipment may include a dry ice source and a wand that is in liquid communication with the dry ice source. The wand is configured to propel dry ice from the dry ice source at a high pressure towards the precipitator.

In accordance with another aspect of the invention, the wand is configured to blast dry ice at various pressures. For instance, the wand may be configured to blast dry ice at a pressure of at least 100 pounds per square inch. In another embodiment, the wand may be configured to blast dry ice at a pressure of at least 200 pounds per square inch. In yet another embodiment, the wand is configured to blast dry ice at a pressure of at least 400 pounds per square inch. Of course, the wand could similarly blast dry ice at other pressures both greater than and less than what is described above as desired by a given user.

In accordance with yet another aspect of the invention, the wand may have a variety of different lengths, which help to achieve the desired pressure. For instance, the wand could have a length of at least 2 feet. In another embodiment, the wand could have a length of at least 4 feet. In yet another embodiment, the wand could have a length of at least 6 feet. Further still, the wand could have a length of at least 7 feet, at least 8 feet, or an even longer length, as desired by a user.

In accordance with another aspect of the invention, the wand may be configured to blast dry ice at a variety of different velocities. In one embodiment, the wand is configured to blast dry ice at a velocity of at least 185 cubic feet per minute. In another embodiment, the wand is configured to blast dry ice at a velocity of at least 800 cubic feet per minute. In yet another embodiment, the wand is configured to blast dry ice at a velocity of at least 1250 cubic feet per minute.

In accordance with another aspect of the invention, the equipment may further include a pressurized pot and a hose connecting the pressurized pot to the wand. In this embodiment, the dry ice media and air are mixed to create a blast stream through the wand.

In accordance with another aspect of the invention, the equipment may also comprise a first hose, a second hose, and a venture suction. In this embodiment, the first hose is for distributing air and the second hose is for distributing dry ice. The venture suction may be located at a nozzle of the wand. The dry ice media and the air may be mixed to create a blast stream through the wand.

In accordance with another aspect of the invention, a method of using the cleaning equipment for cleaning a precipitator that includes a plurality of wires and plates is provided. The method can include the steps of inserting a wand into the precipitator and blasting dry ice out of the wand towards the plurality of wires and plates at a high pressure. The method can also include the step of inserting the wand that has a length of at least 2 feet. Also, the method can include the step of inserting the wand having a length of at least 6 feet. The method can also include the step of blasting the dry ice at a pressure of at least 100 pounds per square inch. Further, the method can include the step of blasting the dry ice at a pressure of at least 400 pounds per square inch. Also, the method can include the step of blasting the dry ice at a velocity of at least 185 cubic feet per minute. The method can further include the step of blasting the dry ice at a velocity of at least 1250 cubic feet per minute.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore nonlimiting, embodiments illustrated in the drawings accompanying and forming a part of this specification, wherein like reference numerals designate the same elements in the several views, and in which:

FIG. 1 illustrates a perspective view of a precipitator that is cleaned by the present invention;

FIG. 2 is a top plan view of the nozzle used to clean the precipitator of FIG. 1.

FIG. 3 is a side elevation view of the nozzle of FIG. 2;

FIG. 4 is a cross-sectional side elevation view of a portion of the nozzle of FIGS. 2 and 3;

FIG. 5 is a cross-sectional end elevation view of the nozzle of FIGS. 2-4;

FIG. 6 is a top plan view of the nozzle hooked up to a pressurized pot; and

FIG. 7 is a top plan view of the nozzle hooked up to an air source and a dry ice source.

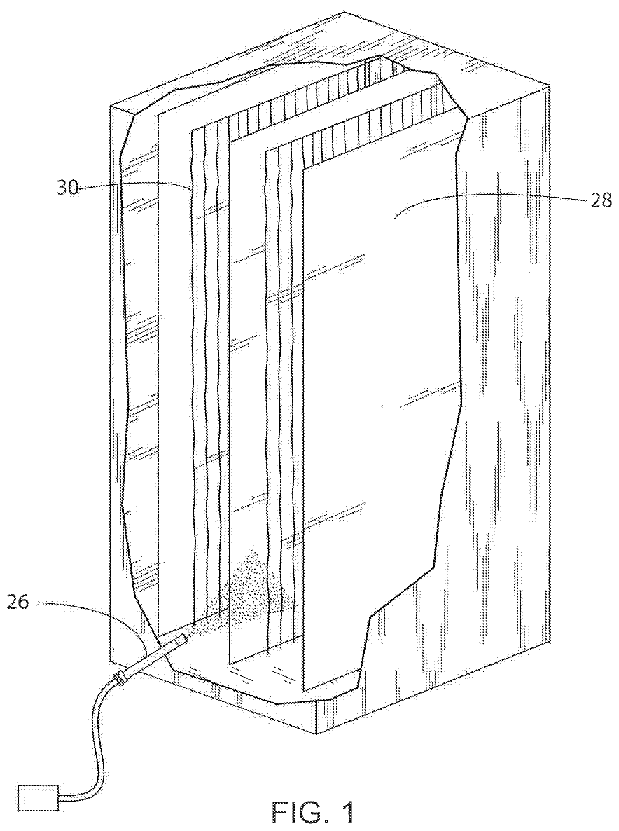

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the words connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

A cleaning equipment 20 for use with a precipitator 22 is provided that includes a dry ice source 24 and a wand 26. The wand 26 is in fluid flow connection with the dry ice source 24. As a result, dry ice can be propelled from the dry ice source 24 out of the wand 26. Preferably, the dry ice can be propelled from the wand 26 at a very high pressure and/or a very high velocity. This is especially desirable for use with the precipitator 22, which can be coated with biproduct waste. Oftentimes, this biproduct waste can have a very strong hold on the various components of the precipitator 22, which makes it increasingly difficult to fully clean the precipitator 22. For instance, precipitators 22 typically have a plurality of different components, including a plurality of plates 28 and a plurality of wires 30. Due to the large number of different components, there is a significant amount of surface area that needs to be cleaned, which again can require a high-pressure output from the wand 26.

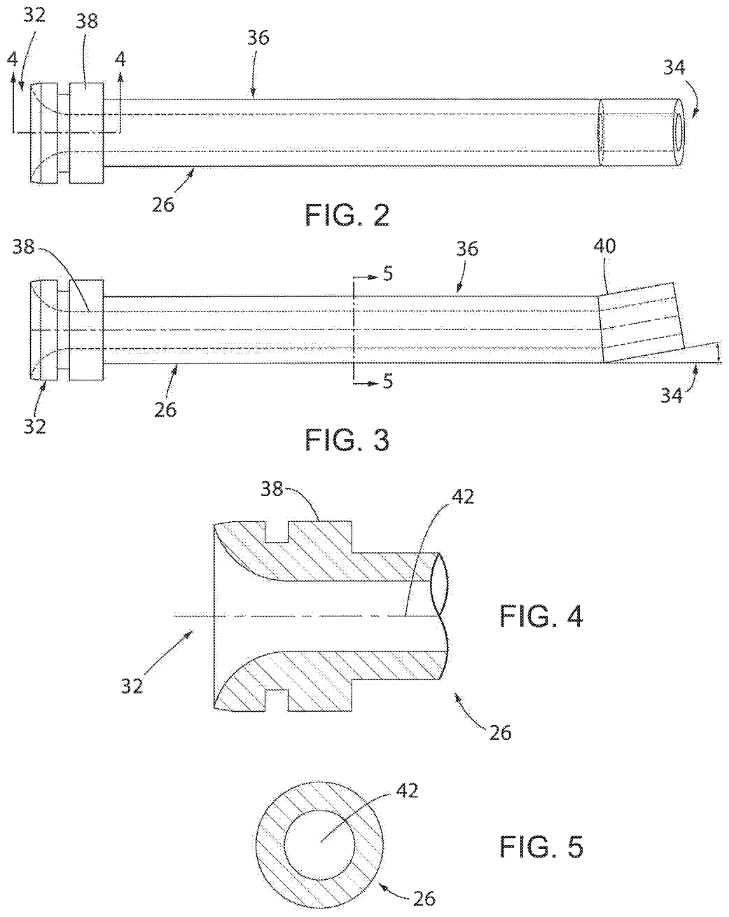

As shown in FIGS. 2-5, the wand 26 will now be further described. The wand 26 has a first entry end 32 and a second exit end 34 with a body 36 extending therethrough. The wand 26 may have various ledges or grooves 38 located adjacent the first entry end 32. These ledges or grooves 38 may allow the wand to be quickly, easily, and securely connected to other components during use or otherwise gripped during use. Additionally, the second exit end 34 may either extend substantially parallel with the body 36 or it may extend at a desired angle. Additionally, the second exit end 34 may have a tip 40 that is angled from the body 36 at a desired angle, again to achieve a desired flow rate out of the wand 26. The wand 26 also has an interior bore 42 extending through the length of the wand 26. The bore allows for dry ice or other media to be sprayed from the first entry end 32, through the body 36, and out the second exit end 34. The diameter of the interior bore 42, as well as the diameter for the overall wand 26, can be varied. For instance, depending on the desired flow characteristics into, through, and out of the wand 26, the diameter could be larger or smaller.

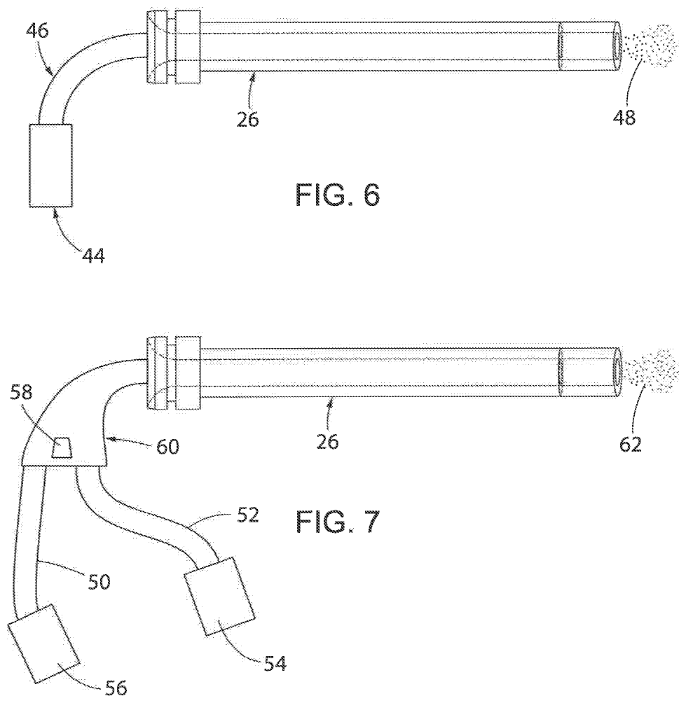

The cleaning equipment 20 can also include other components. For instance, a pressurized pot 44 could be included. See FIG. 6. The pressurized pot 44 could be connected to the wand using a hose 46. As a result, dry ice media 48 and air can be mixed in the pressurized pot 44 to create a blast stream through the wand 26.

Alternatively, the cleaning equipment 20 could have a first hose 50 and a second hose 52. The first hose 50 can be for distributing air, for instance, from an air source 56, and the second hose 52 can be for distributing dry ice, for instance, from a dry ice source 54. See FIG. 7. In such an embodiment a venture suction 58 may also be included that is located at a nozzle 60 of the wand 26. In this embodiment, the dry ice and the air are mixed to create a blast stream through the wand 26, where the mixed media 62 is sprayed out of the second end 34.

Wands 26 equipped to blast dry ice at a variety of different pressures will now be described. The wands 26 may have different configurations in order to result in high pressure. For instance, the wands 26 may be longer than traditional wands in order to achieve the desired high pressure. By way of example, the wand 26 could be at least 2 feet in length. Furthermore, the wand 26 could be at least 4 feet in length. Further still, the wand 26 could be at least 6 feet in length. Further yet, the wand 26 could be at least 7 feet in length. In yet another embodiment, the wand 26 could be at least 8 feet in length. The wand 26 could also be over 10 feet in length. Of course, the length of the wand 26 could vary and be outside of the ranges described above to achieve a desired effect. As discussed above, the diameter of the bore 42 could also be varied to result in different pressures or velocities. Of course, the wands 26 could have many other features to influence the rate with which dry ice is blasted.

In some embodiments, the wand 26 may be configured to blast dry ice at a pressure of at least 100 pounds per square inch. In other embodiments, the wand 26 may be configured to blast dry ice at a pressure of at least 200 pounds per square inch. In yet other embodiments, the wand 26 may be configured to blast dry ice at a pressure of at least 400 pounds per square inch. Of course, the wand 26 could be configured to blast dry ice at a pressure outside of the ranges described above depending on the desired result.

In addition to being equipped to blast thy ice at a desired pressure, the wand 26 could also be configured to blast dry ice at a specific velocity. For instance, in one embodiment, the wand 26 is configured to blast dry ice at a velocity of at least 185 cubic feet per minute. In another embodiment, the wand 26 is configured to blast dry ice at a velocity of at least 800 cubic feet per minute. In yet another embodiment, the wand 26 is configured to blast dry ice at a velocity of at least 1250 cubic feet per minute. In other embodiments, the wand 26 could be configured to blast dry ice at other velocities, as desired.

The equipment 20 may include a single wand 26. Although a single wand 26 has been described above, it should be noted that alternatively, to improve the speed with which a given precipitator is cleaned, the equipment 20 may include multiple wands 26. The number of wands 26 that are used can be dependent on the size of the precipitator 22. For instance, the larger the precipitator 22, the more wands 26 that could be used. In some embodiments, 1, 2, 4, 8, 10, or 20 wands 26 could be used simultaneously. For even larger precipitators, even more wands 26 could be used.

Operation of the equipment 20 will now be described. First, a dry ice source or sources 54 will be connected to a wand 26. Additionally, a pressurized air source 56 may be connected to the wand 26. As described above, this may occur using a variety of different hoses or other connectors that are releasably or permanently mounted to the wand 26. Once the dry ice source and/or pressurized air source are coupled to the wand 26, the wand 26 may either be inserted into the precipitator 22 or located directly adjacent to a precipitator 22. Thereafter, fluid flow will be activated through the wand 26. Once this occurs, a dry ice media will be distributed through the hoses or other connectors into the wand 26 through the first end 32. The dry ice media is then distributed through the body 36 of the wand 26. The wand 26 then sprays or blasts the media out of the second end 34 of the wand 26 into the precipitator 22. The wand 26 is specifically configured to spray or blast the media out of the second end 34 of the wand 26 at a high pressure and/or at a high velocity. The wand 26 is specifically configured to result in these high pressure and high velocities without failure. For instance, the overall length of the wand 26, as well as the size of the diameter of the bore 42 extending therethrough may be specifically selected to maximize the pressure and velocity of the media that exits the wand 26. Once the wand 26 is turned on, the wand 26 is moved about the precipitator 22 and turned as needed to enable cleaning of the entire precipitator 22, including the plates 28 and wires 30 located therein. Additionally, as explained above the equipment 20 may include multiple wands 26. For instance, especially where the precipitator 22 has a large footprint and encloses a large number of plates 28 and wires 30, a large number of wands 26 may be used.

Although the best mode contemplated by the inventors of carrying out the present invention is disclosed above, practice of the present invention is not limited thereto. It will be manifest that various additions, modifications, and rearrangements of the features of the present invention may be made without deviating from the spirit and scope of the underlying inventive concept. In addition, although the components described above will ideally be manufactured from heavy-duty, durable materials, the individual components need not be fabricated from the disclosed materials but could be fabricated from virtually any suitable materials.

Moreover, the individual components need not he formed in the disclosed shapes, or assembled in the disclosed configuration, but could be provided in virtually any shape, and assembled in virtually any configuration to improve the efficiency with which the equipment cleans the precipitator and associated components. Additionally, while the equipment is described as being configured to clean precipitators, including plates and wires associated therewith, it could similarly be used to clean any other devices or machines. Additionally, the equipment is described as using dry ice because it has the beneficial properties of cleaning the equipment without leaving any residue and while being a non-aggressive cleaner that does not damage the materials being cleaned. However, the equipment could similarly be used with any other cleaning medium. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

What is claimed is:

1. A cleaning equipment for use with a precipitator comprising:
a thy ice source; and
a wand in liquid connection with the dry ice source;
wherein the wand is configured to propel dry ice from the dry ice source at a high pressure towards the precipitator.

2. The cleaning equipment for use with a precipitator of claim 1, wherein the precipitator comprises:
a plurality of plates; and
a plurality of wires;
wherein the plurality of plates and the plurality of wires has a waste biproduct attached thereto.

3. The cleaning equipment for use with a precipitator of claim 2, wherein the wand is configured to blast dry ice at a pressure of at least 100 pounds per square inch.

4. The cleaning equipment for use with a precipitator of claim 3, wherein the wand is configured to blast dry ice at a pressure of at least 200 pounds per square inch.

5. The cleaning equipment for use with a precipitator of claim 4, wherein the wand is configured to blast dry ice at a pressure of at least 400 pounds per square inch.

6. The cleaning equipment for use with a precipitator of claim 2, wherein the wand is at least 2 feet in length.

7. The cleaning equipment for use with a precipitator of claim 6, wherein the wand is at least 4 feet in length.

8. The cleaning equipment for use with a precipitator of claim 7, wherein the wand is at least 6 feet in length.

9. The cleaning equipment for use with a precipitator of claim 2, wherein the wand is configured to blast dry ice at a velocity of at least 185 cubic feet per minute.

10. The cleaning equipment for use with a precipitator of claim 9, wherein the wand is configured to blast dry ice at a velocity of at least 800 cubic feet per minute.

11. The cleaning equipment for use with a precipitator of claim 10, wherein the wand is configured to blast dry ice at a velocity of at least 1250 cubic feet per minute.

12. The cleaning equipment for use with a precipitator of claim 2, further comprising:
a pressurized pot; and
a hose connecting the pressurized pot to the wand;
wherein dry ice media and air are mixed to create a blast stream through the wand.

13. The cleaning equipment for use with a precipitator of claim 2, further comprising:
a first hose for distributing air;
a second hose for distributing dry ice; and
a venture suction located at a nozzle of the wand;
wherein dry ice media and air are mixed to create a blast stream through the wand.

14. A method of using a cleaning equipment to clean a precipitator including a plurality of wires and plates comprising the steps of:
inserting a wand into the precipitator; and
blasting dry ice out of the wand towards the plurality of wires and plates at a high pressure.

15. The method of claim 14, further comprising the step of inserting the wand having a length of at least 2 feet.

16. The method of claim 15, further comprising the step of inserting the wand having a length of at least 6 feet.

17. The method of claim 14, further comprising the step of blasting the dry ice at a pressure of at least 100 pounds per square inch.

18. The method of claim 17, further comprising the step of blasting the dry ice at a pressure of at least 400 pounds per square inch.

19. The method of claim 14, further comprising the step of blasting the dry ice at a velocity of at least 185 cubic feet per minute.

20. The method of claim 14, further comprising the step of blasting the dry ice at a velocity of at least 1250 cubic feet per minute.
